(19) United States
(12) Patent Application Publication
(10) Pub. No.: US 2024/0303751 A1
(43) Pub. Date: Sep. 12, 2024

(54) Method for Predicting Carbon Consumption and Carbon Emission of Hydrogen-Rich Blast Furnace (BF) Based on C-rd Theory

(71) Applicant: North China University of Science and Technology, Tangshan City (CN)

(72) Inventors: Yana QIE, Tangshan City (CN); Qing LYU, Tangshan City (CN); Shuhui ZHANG, Tangshan City (CN); Ran LIU, Tangshan City (CN); Fumin LI, Tangshan City (CN); Yanqin SUN, Tangshan City (CN); Chenchen LAN, Tangshan City (CN); Xiaojie LIU, Tangshan City (CN); Jianpeng LI, Tangshan (CN)

(21) Appl. No.: 18/199,340

(22) Filed: May 18, 2023

(30) Foreign Application Priority Data
Mar. 7, 2023 (CN) 2023102080141

(51) Int. Cl. G06Q 50/04; G06F 17/18; G06Q 10/04

(52) U.S. Cl. CPC G06Q 50/04; G06F 17/18; G06Q 10/04; C21B 5/00

(57) ABSTRACT

The present disclosure provides a method for predicting carbon consumption and carbon emission of a hydrogen-rich blast furnace (BF) based on a C-r_{d} theory. The method includes: inputting raw material and fuel conditions, product parameters, injection parameters and a heat loss verification coefficient, determining a reduction degree of hydrogen, and establishing a carbon consumption calculation model; determining a direct reduction degree, predicted values of various carbon consumption items and a predicted fuel ratio according to a carbon balance relation; calculating, if an absolute value of a difference between the predicted fuel ratio and an initial fuel ratio is less than a preset value and the various indicators satisfy constraints on the material and heat balance, and outputting the parameter condition and the corresponding calculation results of the various indicators, or otherwise adjusting the initial fuel ratio, heat loss verification coefficient, the raw material and fuel conditions, and the injection parameters.

### CROSS REFERENCE TO RELATED APPLICATION

This patent application claims the benefit and priority of Chinese Patent Application No. 2023102080141, filed with the China National Intellectual Property Administration on Mar. 7, 2023, the disclosure of which is incorporated by reference herein in its entirety as part of the present application.

### TECHNICAL FIELD

The present disclosure relates to the technical field of metallurgy of iron and steel, and in particular to a method for predicting carbon consumption and carbon emission of a hydrogen-rich blast furnace (BF) based on a C-r_{d} theory.

### BACKGROUND

Hydrogen energy is envisioned as the most promising clean energy in the 21^{st} century. By applying hydrogen (H₂) to iron and steel production instead of carbon, not only is carbon emission reduced, but also the reaction process is accelerated, thereby shifting carbon metallurgy to hydrogen metallurgy. This is an effective way to optimize the energy structure and technological process in the iron and steel industry for the sake of environmental protection, low carbon and sustainable development. The long BF-converter process accounts for at least 90% of the iron and steel smelting process in China. Hydrogen enrichment in a BF is crucial to realize structural transformation of low-carbon energy for the iron and steel in China. However, for many countries with scarce hydrogen resources, there is a lack of practical experience on hydrogen enrichment in the BF and theoretical guidance on various hydrogen enrichment processes. The hydrogen enrichment in the BF uses pollution-free hydrogen to replace a part of carbon to participate in reduction. However, the hydrogen absorbs heat in reduction. Effects of the hydrogen enrichment on carbon consumption for heat supply, chemical carbon consumption, total carbon consumption and carbon emission in the BF are unclear. Potentials of different hydrogen enrichment processes in energy conservation and emission reduction haven't been analyzed effectively. Hence, a prediction method for injection of coke oven gas (COG), natural gas, pure hydrogen and coal gas, circulation of top gas and the like in the BF is desired urgently, so as to establish relations of injection parameters in hydrogen enrichment with carbon consumption in the BF, predict and evaluate carbon emission of different hydrogen enrichment processes in the BF, elaborate sources and directions of carbon in the BF upon the hydrogen enrichment, and analyze potentials of different hydrogen enrichment processes to replace carbon with hydrogen. This is of great significance to hydrogen-rich smelting in the BF.

### SUMMARY

An objective of the present disclosure is to provide a method for predicting carbon consumption and carbon emission of a hydrogen-rich BF based on a C-r_{d} theory. In view of influences of hydrogen, the present disclosure establishes relations of operation parameters in different hydrogen enrichment processes with carbon consumption and carbon emission in the BF to obtain a carbon consumption calculation model, determines a direct reduction degree and a reduction degree of the hydrogen, and predicts various carbon consumption items and fuel ratios of the different hydrogen enrichment processes according to the carbon consumption calculation model. The present disclosure predicts and evaluates the carbon consumption and carbon emission in the BF, and elaborates the carbon source and the carbon direction in the operation parameters of the different hydrogen enrichment processes, thereby providing theoretical guidance for hydrogen enrichment of the BF and low-carbon energy transformation of the BF.

To achieve the above objective, the present invention provides the following technical solutions:

A method for predicting carbon consumption and carbon emission of a hydrogen-rich BF based on a C-r_{d} theory includes:
inputting raw material and fuel conditions, product parameters, injection parameters and a heat loss verification coefficient of a BF, where the raw material and fuel conditions include a type of iron ore, a burden structure, an initial fuel ratio, chemical components of a raw material and a fuel, and blast parameters; the blast parameters include a blast humidity, a blast temperature, an initial blast volume, an oxygen enrichment rate, and an oxygen (O₂) purity; the product parameters include components of molten iron, a temperature of the molten iron, components of slag, a carbon monoxide (CO) utilization rate, components of dust, and a dust volume; and the injection parameters include a type of an injected hydrogen-rich medium, an injection amount of the hydrogen-rich medium, an injection temperature, an injection position, and a hydrogen (H₂) utilization rate;
determining a reduction degree of hydrogen according to the blast parameters, the initial fuel ratio and the injection parameters;
respectively establishing relations of various carbon consumption items of the BF with a direct reduction degree according to the reduction degree of the hydrogen, the raw material and fuel conditions, the product parameters, the injection parameters and the heat loss verification coefficient to obtain a carbon consumption calculation model, where the various carbon consumption items include carburization of BF molten iron, carbon consumption in direct reduction of trace elements, carbon consumption in direct reduction of iron oxide, carbon consumption in chemical reaction, and carbon consumption for heat supply; and the carbon consumption calculation model includes a function for calculating an amount of the carburization of the BF molten iron, a function for calculating an amount of the carbon consumption in the direct reduction of the trace elements, a function for calculating an amount of the carbon consumption in the direct reduction of the iron oxide, a function for calculating an amount of the carbon consumption in the chemical reaction, and a function for calculating an amount of the carbon consumption for the heat supply;
determining the direct reduction degree according to a carbon balance relation, and determining predicted values of the various carbon consumption items and a predicted fuel ratio according to the direct reduction degree and the carbon consumption calculation model;
determining whether an absolute value of a difference between the predicted fuel ratio and the initial fuel ratio is less than a preset value to obtain a first determination result;
adjusting, if the first determination result indicates no, the initial fuel ratio and the initial blast volume, and going back to the step of “determining a reduction degree of hydrogen according to the blast parameters, the initial fuel ratio and the injection parameters”;
calculating, if the first determination result indicates yes, a material balance and a heat balance of the BF according to the direct reduction degree, the reduction degree of the hydrogen and the predicted fuel ratio to obtain calculation results of various indicators, where the calculation results of the various indicators include the predicted values of the various carbon consumption items, carbon emission per ton of iron, the predicted fuel ratio, a raceway adiabatic flame temperature (RAFT) in a tuyere area, a heat loss in a high-temperature area, a temperature of top gas in a low-temperature area, and an overall heat loss of the BF;
determining whether the calculation results of the various indicators satisfy constraints on a material balance and a heat balance in each of areas of the BF to obtain a second determination result, where the constraints on the material balance and the heat balance in each of the areas of the BF include a constraint on a material balance in the tuyere area, a constraint on a heat balance in the tuyere area, a constraint on the RAFT, a constraint on a material balance in the high-temperature area, a constraint on a heat balance in the high-temperature area, a constraint on a material balance in the low-temperature area, a constraint on a heat balance in the low-temperature area, a constraint on a material balance in the whole furnace, and a constraint on a heat balance in the whole furnace;
adjusting, if the second determination result indicates no, the heat loss verification coefficient, the raw material and fuel conditions, and the injection parameters, and going back to the step of “determining a reduction degree of hydrogen according to the blast parameters, the initial fuel ratio and the injection parameters”; and
outputting, if the second determination result indicates yes, the raw material and fuel conditions, the product parameters, the injection parameters, the heat loss verification coefficient and the corresponding calculation results of the various indicators, where the calculation results of the various indicators are used to evaluate a carbon source, a carbon direction, carbon consumption and carbon emission of the BF.

Optionally, the function for calculating the amount of the carburization of the BF molten iron is specifically expressed by:

$${w ( C )}_{carburization} = 1.34 + 2.54 \times 1 {0}^{- 3} t + 0.04 \times w [ Mn ] - 0.30 w [ Si ] - 0.35 w [ P ] - 0.4 w [ S ] ,$$

where, w(C)_{carburization} is the amount of the carburization of the BF molten iron, t is the temperature of molten iron, w[Mn] is a content of manganese (Mn) in the molten iron, w[Si] is a content of silicon (Si) in the molten iron, w[P] is a content of phosphorus (P) in the molten iron, and w[S] is a content of sulfur (S) in the molten iron.

Optionally, the function for calculating the amount of the carbon consumption in the direct reduction of the trace elements is specifically expressed by:

$${w ( C )}_{Si , Mn , P} = \frac{12}{28} \times 2 \times w [ Si ] + \frac{12}{56} \times w [ Mn ] + \frac{60}{62} \times w [ P ] ,$$

where, w(C)_{Si,Mn,P} is the amount of the carbon consumption in the direct reduction of the trace elements.

Optionally, the function for calculating the amount of the carbon consumption in the direct reduction of the iron oxide is specifically expressed by:

$${w ( C )}_{d} = \frac{12}{56} \times w [ Fe ] \times {r}_{d} ,$$

where, w(C)_{d} is the amount of the carbon consumption in the direct reduction of the iron oxide, w[Fe] is a content of ferrum (Fe) in the molten iron, and r_{d} is the direct reduction degree.

Optionally, the function for calculating the amount of the carbon consumption in the chemical reaction is specifically expressed by:

$${w ( C )}_{i} = {n}_{1} \times \frac{12}{56} ( 1 - {r}_{d} - {r}_{{H}_{2}} ) \times w [ Fe ] + \frac{12}{56} \times {n}_{2} \times \frac{1}{3} ( {r}_{d} + {r}_{{H}_{2}} ) \times w [ Fe ] = \frac{1}{{η}_{c o}} {w ( C )}_{C {O}_{2}} ,$$

where, w(C)ᵢ is the amount of the carbon consumption in the chemical reaction, r_{H}_{₂} is the reduction degree of the hydrogen, η_{CO} is the CO utilization rate, w(C)_{CO}_{₂} is an amount of carbon reduced to generate carbon dioxide (CO₂), n₁ is an excess coefficient of a reductant CO for reducing ferrous oxide (FeO) to Fe, and n₂ is an excess coefficient of the reductant CO for reducing ferroferric oxide (Fe₃O₄) to FeO.

Optionally, the reduction degree of the hydrogen is calculated by:

$${r}_{{H}_{2}} = {w}_{{H}_{2}} {η}_{{H}_{2}} \times \frac{56}{22.4} \times \frac{1}{10 \times W [ Fe ]} = [ K \times {( H )}_{fuel} \times 11.2 + {V}_{b} \times {( {H}_{2} )}_{b} + {V}_{injection} \times {( {H}_{2} )}_{injection} ] \times {η}_{{H}_{2}} \times \frac{56}{22.4} \times \frac{1}{10 \times w {[}_{Fe ]}} ,$$

where, η_{H}_{₂} is the H₂ utilization rate, w_{H}_{₂} is a total volume of H₂ charged to the furnace, specifically including a total volume of H₂ from cracking of water (H₂O) in the fuel and blast air as well as injected H₂, K is the initial fuel ratio, V_{b} is the initial blast volume, V_{injection} is a volume of the injected hydrogen-rich medium, (H₂)_{fuel} is an equivalent H₂ volume in the fuel, (H₂)_{b} is an equivalent H₂ volume in the blast air, and (H₂)_{injection} is an equivalent H₂ volume in the injected hydrogen-rich medium.

Optionally, the amount of the carbon reduced to generate the CO₂ is calculated by:

$${w ( C )}_{{CO}_{2}} = \frac{12}{56} w [ Fe ] ( 1 - {r}_{d} - {r}_{{H}_{2}} ) + \frac{1}{2} \times \frac{12}{56} w [ Fe ] .$$

Optionally, the function for calculating the amount of the carbon consumption for the heat supply is specifically expressed by:

$$w ( C ) = {w ( C )}_{c o m bustion} + {w ( C )}_{d} ,$$

where, w(C) is the amount of the carbon consumption for the heat supply, and w(C)_{combustion} is an amount of carbon combusted in front of a tuyere.

Optionally, the amount of the carbon combusted in front of the tuyere is calculated by:

$${w ( C )}_{combustion} ( {q}_{CO} + {q}_{hot blast} ) + {Q}_{injection} + {Q}_{others} = {Q}_{reduction} + {Q}_{molten iron} + {Q}_{slag} + {Q}_{top gas} + {Q}_{{H}_{2 O cracking}} + {Q}_{heat loss} + {Q}_{cracking of pulverized coal} + {Q}_{{H}_{2 O evaporation}} + {Q}^{′} ,$$

where, q_{CO} is heat that 1 kg of carbon is combusted in front of the tuyere to generate CO, q_{hot blast} is heat carried in by the blast air, Q_{injection} is physical heat carried by the injected hydrogen-rich medium, Q_{reduction} is heat consumed by reduction, Q_{molten iron} is heat carried off by the molten iron, Q_{slag} is heat carried off by the slag, Q_{top gas} is heat carried off by top gas,

$${Q}_{{H}_{{2}_{0 cracking}}}$$

is heat consumed by cracking of H₂O in front of the tuyere, Q_{cracking of pulverized coal} is heat consumed by cracking of pulverized coal in front of the tuyere,

$${Q}_{{H}_{2} O evaporation}$$

is heat carried off by evaporation of H₂O in the raw material and the fuel of the BF, Q_{heat loss} is a heat loss, Q′ is the heat loss verification coefficient, and Qₒₜₕₑᵣ is other heat of the BF, including heat carried in by hot charging of the raw material of the BF;
the heat consumed by the reduction is calculated by:

$${Q}_{reduction} = {\sum }_{k} {Q}_{reduction , k} = {Q}_{direct reduction} + {Q}_{indirect reduction} + {Q}_{S i , Mn , P} = \frac{152190}{56} w [ Fe ] \times {r}_{d} + \frac{47522}{2 \times 72} {w}_{s i l i c a t e} + \frac{1549}{160} {w}_{F {e}^{2}} {o}_{3} + \frac{20883}{232} {w}_{F {e}^{3}} {o}_{4} + \frac{27718}{56} w {[}_{Fe ]} \times {r}_{{H}_{2}} - \frac{13605}{56} w {[}_{F e ] ( 1 -} {r}_{d} - {r}_{{H}_{2}} ) + 5087 \times w {[}_{M n ] + 22049 \times } w [ Si ] + 15490 \times w [ P ]$$

where, k denotes different reduction items, Q_{direct reduction} is heat consumed by the direct reduction of the iron oxide, Q_{indirect reduction} is heat consumed by indirect reduction of the iron oxide, Q_{Si,Mn,P} is heat consumed by the reduction of the trace elements, w_{silicate} is a mass of sulfur dioxide (SO₂) in an iron bearing material, w_{Fe}_{₂}_{O}_{₃} is a mass of Fe₂O₃ in the iron bearing material, and w_{Fe}_{₃}_{O}_{₄}, is a mass of Fe₃O₄ in the iron bearing material; and
the heat carried off by the top gas is calculated by:

$${Q}_{top gas} = {Q}_{{CO}^{{2}^{, top gas}}} + {Q}_{CO , top gas} + {Q}_{{N}_{2} , top gas} + {Q}_{{H}_{2} , top gas} + {Q}_{{H}_{2} O , top gas} = \frac{{q}_{{CO}^{{2}^{, top gas}}}}{12} {w ( C )}_{{CO}^{2}} + \frac{{q}_{CO , top gas}}{12} ( {w ( C )}_{i} - {w ( C )}_{{CO}^{2}} ) + \frac{{q}_{{N}_{2} , top gas}}{22.4} \times {( {N}_{2} )}_{b} \times {V}_{b} + \frac{{q}_{{H}_{2} , top gas}}{2} {w}_{{H}_{2}} {η}_{{H}_{2}} + \frac{{q}_{{H}_{2} O , top gas}}{2} \times {w}_{{H}_{2}} ( 1 - {η}_{{H}_{2}} ) ,$$

where, Q_{CO}_{²}_{,top gas} is heat carried off by CO₂ in the top gas, Q_{CO,top gas} is heat carried off by CO in the top gas, Q_{N}_{₂}_{,top gas} is heat carried off by nitrogen (N₂) in the top gas,

$${Q}_{{H}_{2 , top gas}}$$

is heat carried off by H₂ in the top gas,

$${Q}_{{H}_{2} O , top gas}$$

is heat carried off by H₂O in the top gas, q_{CO}_{²}_{,top gas} is heat carried off by 1 mol of CO₂ in the top gas, g_{CO,top gas} is heat carried off by 1 mol of CO in the top gas,

$${q}_{{N}_{2} , top gas}$$

is heat carried off by 1 mol of N₂ in the top gas,

$${q}_{{H}_{2} , top gas}$$

is heat carried off by 1 mol of H₂ in the top gas,

$${q}_{{H}_{2} O , top gas}$$

is heat carried off by 1 mol of H₂O in the top gas, and (N₂)_{b} is a volume fraction of N₂ in the hot blast.

Optionally, the carbon balance relation is specifically expressed by:

$${w ( C )}_{i} = {C}_{injection} + w ( C ) + {w ( C )}_{carburization} + {w ( C )}_{Si , Mn , P} ,$$

where, C_{injection} is an equivalent amount of carbon carried in by the injected hydrogen-rich medium.

Optionally, the predicted fuel ratio is calculated by:

$${K}^{′} = ( w ( C ) + {w ( C )}_{Si , Mn , P} + {w ( C )}_{carburization} ) / {w ( C )}_{k} ,$$

where, K′ is the predicted fuel ratio, and w(C)ₖ is a mass percent of carbon in the fuel.

Optionally, the adjusting the initial fuel ratio and the initial blast volume specifically includes:
updating the initial fuel ratio with a sum of the predicted fuel ratio and the preset value; and
determining a predicted blast volume according to a carbon-oxygen balance in front of a tuyere, and updating the initial blast volume with the predicted blast volume, where the predicted blast volume is calculated by:

$${V}_{b}^{′} = \frac{{w ( C )}_{c o m b u s t t o n} \times 22.4}{24 \times {v ( {O}_{2} )}_{b}} ,$$

where, V_{b}′ is the predicted blast volume, and v(O₂)_{b} is a volume fraction of O₂ in hot blast.

Optionally, after the respectively establishing relations of various carbon consumption items of the BF with a direct reduction degree according to the reduction degree of the hydrogen, the raw material and fuel conditions, the product parameters, the injection parameters and the heat loss verification coefficient to obtain a carbon consumption calculation model, the method further includes:
drawing and outputting a carbon consumption line distribution diagram according to the carbon consumption calculation model.

According to the specific embodiments provided by the present disclosure, the present disclosure provides the following technical effects:

The present disclosure is realized based on the C-r_{d} theory. According to blast parameters, an initial fuel ratio and injection parameters, a reduction degree of hydrogen is determined. According to the reduction degree of the hydrogen, raw material and fuel parameters, product parameters, the injection parameters and a heat loss verification coefficient, relations of various carbon consumption items of a BF with a direct reduction degree are respectively established to obtain a carbon consumption calculation model. Based on a carbon balance relation and the carbon consumption calculation model, the direct reduction degree, predicted values of the various carbon consumption items and a predicted fuel ratio are determined. Through double loop iteration, the initial fuel ratio and the initial blast volume are adjusted constantly, such that the predicted fuel ratio satisfies a preset condition. Then, the heat loss verification coefficient, the raw material and fuel conditions and the injection parameters are adjusted constantly, such that calculation results of various indicators based on the predicted fuel ratio satisfy constraints on a material balance and a heat balance in each of areas of the BF. Until various conditional parameters of the BF at present satisfy production requirements, the conditional parameters and the corresponding calculation results of the various indicators are output. Therefore, the present disclosure can evaluate energy conservation, emission reduction and carbon emission of such hydrogen enrichment processes as injection of COG into the BF, injection of coal and COG into the BF, injection of coal and pure hydrogen into the BF, injection of coal into the BF by preheating the injected medium, and circulation of top gas, and elaborate a carbon source, a carbon direction, carbon consumption and carbon emission in operation parameters of different hydrogen enrichment processes. This provides theoretical guidance for hydrogen enrichment of the BF and low-carbon energy transformation of the BF.

### BRIEF DESCRIPTION OF THE DRAWINGS

To describe the technical solutions in the examples of the present disclosure or in the prior art more clearly, the accompanying drawings required for the examples are briefly described below. Apparently, the accompanying drawings in the following description show merely some examples of the present disclosure, and those of ordinary skill in the art may still derive other accompanying drawings from these accompanying drawings without creative efforts.

FIG. 1 is a method for predicting carbon consumption and carbon emission of a hydrogen-rich BF based on a C-r_{d} theory according to the present disclosure;

FIG. 2 illustrates a carbon consumption line distribution diagram of a BF in all-coke smelting and coal injection according to the present disclosure;

FIG. 3 illustrates a carbon consumption line distribution diagram of a BF in single COG injection according to the present disclosure; and

FIG. 4 illustrates a carbon consumption line distribution diagram of a BF in injection of coal+COG according to the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

An objective of the present disclosure is to provide a method for predicting carbon consumption and carbon emission of a hydrogen-rich BF based on a C-r_{d} theory, so as to obtain relations of operation parameters in different hydrogen enrichment processes with carbon consumption and carbon emission of the BF, predict and evaluate carbon consumption and carbon emission of the different hydrogen enrichment processes, and elaborate a carbon source, a carbon direction, carbon consumption and carbon emission in the operation parameters of the different hydrogen enrichment processes, thereby providing theoretical guidance for hydrogen enrichment of the BF and low-carbon energy transformation of the BF.

The present disclosure uses the following technical solutions: According to a principle of a C-r_{d} relation proposed by A. H. Ramm (namely a C-r_{d} theory), and in view of influences of hydrogen, linear relations of carbon consumption items in a BF with a direct reduction degree r_{d} are established. The carbon consumption items in the BF include carburization of molten iron, carbon consumption in reduction of trace elements, carbon consumption in direct reduction of iron, carbon consumption in indirect reduction, and carbon consumption for heat supply. The relations of the various carbon consumption items with the r_{d} are calculated. Loop iteration is carried out according to a carbon balance relation to obtain the r_{d}, r_{H}_{₂} and a predicted fuel ratio. The r_{d}, the r_{H}_{₂} and the predicted fuel ratio are used to calculate a material balance and a heat balance in each of areas of the BF. According to constraints on the material balance and the heat balance in the area, a heat loss verification coefficient, raw material and fuel conditions, and injection parameters are adjusted constantly, thereby predicting various carbon consumption items and carbon emission of the BF in different hydrogen enrichment processes.

To make the above objectives, features, and advantages of the present disclosure clearer and more comprehensible, the present disclosure will be further described in detail below with reference to the accompanying drawings and the specific implementations.

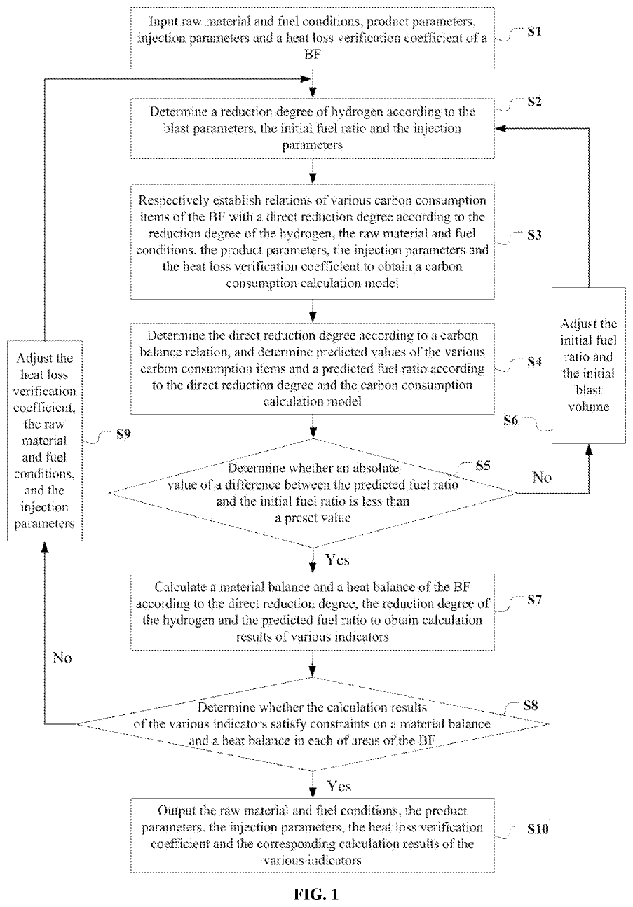

As shown in FIG. 1, the present disclosure provides a carbon evaluation method for a hydrogen-rich BF, including the following steps:
Step S1: Input raw material and fuel conditions, product parameters, injection parameters and a heat loss verification coefficient of a BF, where the raw material and fuel conditions include a type of iron ore, a burden structure, an initial fuel ratio, chemical components of a raw material and a fuel, and blast parameters; the blast parameters include a blast humidity, a blast temperature, an initial blast volume, an oxygen enrichment rate, and a O₂ purity; the product parameters include components of molten iron, a temperature of the molten iron, components of slag, a CO utilization rate, components of dust, and a dust volume; and the injection parameters include a type of an injected hydrogen-rich medium, an injection amount of the hydrogen-rich medium, an injection temperature, an injection position, and a H₂ utilization rate.
Step S2: Determine a reduction degree of hydrogen according to the blast parameters, the initial fuel ratio and the injection parameters.
Step S3: Respectively establish relations of various carbon consumption items of the BF with a direct reduction degree according to the reduction degree of the hydrogen, the raw material and fuel conditions, the product parameters, the injection parameters and the heat loss verification coefficient to obtain a carbon consumption calculation model, where the various carbon consumption items include carburization of BF molten iron, carbon consumption in direct reduction of trace elements, carbon consumption in direct reduction of iron oxide, carbon consumption in chemical reaction, and carbon consumption for heat supply; and the carbon consumption calculation model includes a function for calculating an amount of the carburization of the BF molten iron, a function for calculating an amount of the carbon consumption in the direct reduction of the trace elements, a function for calculating an amount of the carbon consumption in the direct reduction of the iron oxide, a function for calculating an amount of the carbon consumption in the chemical reaction, and a function for calculating an amount of the carbon consumption for the heat supply.

Specifically, according to the raw material and fuel conditions (namely raw material conditions and fuel conditions) of the BF and product requirements, relations of the carburization of the BF molten iron, the carbon consumption in the direct reduction of the trace elements, the carbon consumption in the direct reduction of the iron oxide, the carbon consumption in the chemical reaction and the carbon consumption for the heat supply with the direct reduction degree are established. The relation of each carbon consumption item C and the direct reduction degree r_{d} is calculated as follows:
(1) The amount w(C)_{carurtization} of the carburization of the molten iron:

$${w ( C )}_{carburization = 1.34 + 2. 54 \times 1} {0}^{- 3} t + 0.04 \times w {[}_{Mn ] - 0.3} w [ Si ] - 0.35 w [ P ] - 0.4 w [ S ] \qquad ( 1 )$$

where, t is the temperature of the molten iron; w[Mn], w[Si], w[P] and w[S] are respectively contents of elements in the molten iron by a mass percent; 2.54, 0.04, 0.3, 0.35 and 0.4 are respectively relational coefficients of the amount of the carburization with the temperature, w[Mn], w[Si], w[P], and w[S] in the molten iron.
(2) The amount w(C)_{Si,Mn,P} of the carbon consumption in the direct reduction of the trace elements:

$${w ( C )}_{Si , Mn , P} = \frac{12}{28} \times 2 \times w [ Si ] + \frac{12}{56} \times w [ Mn ] + \frac{60}{62} \times w [ P ] \qquad ( 2 )$$

where, 12/28×2, 12/56 and 60/62 are respectively masses of carbon consumed to reduce 1 mol of [Si], 1 mol of [Mn] and 1 mol of [P].
(3) The amount w(C)_{d} of the carbon consumption in the direct reduction of the iron oxide:

$${w ( C )}_{d} = \frac{12}{56} \times w [ Fe ] \times {r}_{d} \qquad ( 3 )$$

where, r_{d} is the direct reduction degree defined by the Pavlov, and specifically refers to a direct reduction degree of [Fe].
(4) The amount of the carbon consumption in the chemical reaction, namely an amount w(C)ᵢ of carbon consumption in indirect reduction of the iron oxide:

$${w ( C )}_{i} = {n}_{1} \times \frac{12}{56} ( 1 - {r}_{d} - {r}_{{H}_{2}} ) \times w [ Fe ] + \frac{12}{56} \times {n}_{2} \times \frac{1}{3} ( {r}_{d} + {r}_{{H}_{2}} ) \times w [ Fe ] = \frac{1}{{η}_{CO}} {w ( C )}_{{CO}_{2}} \qquad ( 4 )$$

$${w ( C )}_{{CO}_{2}} = \frac{12}{56} w [ Fe ] ( 1 - {r}_{d} - {r}_{{H}_{2}} ) + \frac{1}{2} \times \frac{12}{56} w [ Fe ] + {w ( C )}_{Si , Mn , P} \qquad ( 5 )$$

$${r}_{{H}_{2}} = {w}_{{H}_{2}} {η}_{{H}_{2}} \times \frac{56}{2} \times \frac{1}{w {[}_{F e ]}} = [ K \times {( {H}_{2} )}_{fuel} + {V}_{b} \times {( {H}_{2} )}_{b} + {V}_{injection} \times {( {H}_{2} )}_{injection} ] \times {η}_{{H}_{2}} \times \frac{56}{2} \times \frac{1}{w {[}_{Fe ]}} \qquad ( 6 )$$

where, r_{H}_{₂} is the reduction degree of the hydrogen, η_{H}_{₂} is the H₂ utilization rate, w_{H}_{₂} is a total volume of H₂ charged to the furnace, specifically including H₂ from cracking of H₂O in the raw material, the fuel and blast air as well as injected H₂, K is the initial fuel ratio, V_{b} is the initial blast volume, V_{injection} is a mass of an injected hydrogen-rich medium, (H₂)_{fuel}, (H₂)_{b}, and (H₂)_{injection} are respectively equivalent H₂ volumes in the fuel, the blast air and the injected hydrogen-rich medium, η_{CO} is a CO utilization rate in coal gas, w(C)_{CO}_{₂} is an amount of carbon reduced to generate CO₂, n₁ is an excess coefficient of a reductant CO for reducing FeO to Fe, and n₂ is an excess coefficient of the reductant CO for reducing Fe₃O₄ to FeO.
(5) The amount w(C) of the carbon consumption from the heat supply:

$$w ( C ) = {w ( C )}_{combustion} + {w ( C )}_{d} \qquad ( 7 )$$

where, w(C) is the amount of the carbon consumption for the heat supply, and w(C)_{combustion} is an amount of carbon combusted in front of a tuyere and may be calculated through a second heat balance of the BF, namely Σᵢ Q_{heatsupply}_{ᵢ}=Σⱼ Q_{heat consumption j}, Σᵢ Q_{heat supply i} being a total amount of heat supply per ton of iron, and Σⱼ Q_{heat consumption j} being a total amount of heat consumption per ton of iron, at a unit of kJ/tFe. Specifically:

$${w ( C )}_{combustion} ( {q}_{CO} + {q}_{hot blast} ) + {Q}_{injection} + {Q}_{others} = {Q}_{reduction} + {Q}_{molten iron} + {Q}_{slag} + {Q}_{top gas} + {Q}_{{H}_{2 O cracking}} + {Q}_{heat loss} + {Q}_{cracking of pulverized coal} + {Q}_{{H}_{2 O evaporation}} + {Q}^{′} \qquad ( 8 )$$

where, q_{CO} is heat that 1 kg of carbon is combusted in front of the tuyere to generate CO; q_{hot blast} heat carried in by hot-blast air required to combust 1 kg of carbon; Q_{injection} is physical heat carried by the injected hydrogen-rich medium, which is associated with the injection amount of the hydrogen-rich medium and the injection temperature, and calculated by Eq. (9); Qₒₜₕₑᵣₛ is other heat of the BF, such as heat carried in by hot charging of the raw material of the BF; Q_{reduction} is heat consumed by reduction, which is associated with the direct reduction degree, the reduction degree of the hydrogen and the components of the molten iron, and calculated by Eq. (10); Q_{molten iron} is heat carried off by the molten iron; Q_{slag} is heat carried off by the slag; Q_{top gas} is heat carried off by top gas, which is associated with components and a temperature of the top gas and calculated by Eq. (11), the components of the top gas depending on the direct reduction degree and the reduction degree of the hydrogen;

$${Q}_{{H}_{{2}_{0 cracking}}}$$

is heat consumed by cracking of H₂O in front of the tuyere; Q_{heat loss} is a heat loss, which is specifically 5-10% of total heat; Q_{cracking of pulverized coal} is heat consumed by cracking of pulverized coal in front of the tuyere;

$${Q}_{{H}_{{2}_{0 evaporation}}}$$

is heat carried off by evaporation of H₂O in the raw material and the fuel of the BF; and Q′ is the heat loss verification coefficient. As can be seen, except that Q_{reduction} and Q_{top gas} are associated with the direct reduction degree and the reduction degree of the hydrogen, other items can be solved by the raw material and fuel conditions of the BF, the product parameters and the injection parameters to obtain specific values. The reduction degree of the hydrogen can also be obtained by Eq. (6). Hence, a relation between w(C)_{combustion} and the direct reduction degree r_{d} can be established, and substituted into Eq. (7) to obtain a relation between w(C) and the r_{d}.

$${Q}_{injectιon} = {\sum }_{i} {\int }_{298}^{{T}_{injection}} {c}_{P , i} dT \qquad ( 9 )$$

where, T_{injection} is the injection temperature, i is the injected hydrogen-rich medium, and c_{P,i} is a molar heat capacity at a constant pressure for the injected hydrogen-rich medium i.

$${Q}_{reduction} = {\sum }_{k} {Q}_{reduction , k} = {Q}_{direct reduction} + {Q}_{indirect reduction} + {Q}_{Si , Mn , P} = \frac{152190}{56} w [ Fe ] \times {r}_{d} + \frac{47522}{2 \times 72} {w}_{silicate} + \frac{1549}{160} {w}_{{Fe}^{2} {O}_{3}} + \frac{20883}{232} {w}_{{Fe}^{3} {O}_{4}} + \frac{27718}{56} w [ Fe ] \times {r}_{{H}_{2}} - \frac{13605}{56} w [ Fe ] ( 1 - {r}_{d} - {r}_{{H}_{2}} ) + 5087 \times w [ Mn ] + 22049 \times w [ Si ] + 15490 \times w [ P ] \qquad ( 10 )$$

where, k denotes different reduction items; Q_{direct reduction} is heat consumed by the direct reduction of the iron oxide, Q_{indirect reduction} is heat consumed by the indirect reduction of the iron oxide, and Q_{Si,Mn,P} is heat consumed by the reduction of the trace elements, at a unit of kJ/tFe; w_{silicate} is a mass of SiO₂ in an iron bearing material, w_{Fe}_{₂}_{O}_{₃} is a mass of Fe₂O₃ in the iron bearing material, and w_{Fe}_{₃}_{O}_{₄} is a mass of Fe₃O₄ in the iron bearing material, at a unit of kg/tFe; 152190/56 is heat consumed to indirectly reduce 1 mol of FeO, 47522/2×72 is heat consumed to reduce SiO₂, 1549/160 is heat consumed to reduce Fe₂O₃, 20883/232 is heat consumed to reduce Fe₃O₄, 27718/56 is heat consumed to reduce the hydrogen, 5087 is heat consumed to reduce Mn, 22049 is heat consumed to reduce Si, 15490 is heat consumed to reduce P, and −13605/56 is heat released by reducing 1 mol of FeO with CO.

$${Q}_{top gas} = {Q}_{{CO}^{2} , top gas} + {Q}_{CO , top gas} + {Q}_{{N}_{2} , top gas} + {Q}_{{H}_{2} , top gas} + {Q}_{{H}_{2} O , top gas} = \frac{{q}_{{CO}^{2} , top gas}}{12} w {( C )}_{{CO}^{2}} + \frac{{q}_{CO , top gas}}{12} ( {w ( C )}_{i} - {w ( C )}_{{CO}^{2}} ) + \frac{{q}_{{N}_{2} , top gas}}{22.4} \times {( {N}_{2} )}_{b} \times {V}_{b} + \frac{{q}_{{H}_{2} , top gas}}{2} {w}_{{H}_{2}} {η}_{{H}_{2}} + \frac{{q}_{{H}_{2} O , top gas}}{2} \times {w}_{{H}_{2}} ( 1 - {η}_{{H}_{2}} ) \qquad ( 11 )$$

where, Q_{CO}_{²}_{,top gas}, Q_{CO,top gas},

$${Q}_{{N}_{2} , top gas} , {Q}_{{H}_{2} , top gas} , {Q}_{{H}_{2} O , top gas}$$

respectively heat carried off by CO₂, CO, N₂, H₂ and H₂O in the top gas, at a unit of kJ/tFe; q_{CO}_{²}_{,top gas}, q_{CO,top gas},

$${Q}_{{N}_{2} , top gas} , {Q}_{{H}_{2} , top gas} , {Q}_{{H}_{2} O , top gas}$$

are respectively heat carried off by 1 mol of CO₂, 1 mol of CO, 1 mol of N₂, 1 mol of H₂ and 1 mol of H₂O in the top gas, at a unit of kJ/mol, and calculated by Eq. (12); V_{b} is the initial blast volume; and (N₂)_{b} is a volume fraction of N₂ in the blast air.

$${q}_{j , top gas} = {\int }_{298}^{{T}_{top gas}} {c}_{P , j} d T \qquad ( 12 )$$

where, j is a component of the top gas, mainly including CO₂, CO, N₂, H₂ and H₂O, c_{P,j} is a molar heat capacity at a constant pressure for the component j, for example: c_{P,O}_{₂} is a molar heat capacity at a constant pressure for O₂, and c_{P,N}_{₂} is a molar heat capacity at a constant pressure for N₂; and T_{top gas} is a temperature of the top gas.

After the relations of the various carbon consumption items with the direct reduction degree are established, the carbon consumption calculation model is obtained. When the direct reduction degree is within [0, 1−r_{H}_{₂}], a carbon consumption line distribution diagram is drawn with the direct reduction degree as a horizontal axis and the carbon consumption as a longitudinal coordinate. It is to be noted that the carbon consumption in the direct reduction, the carbon consumption in the chemical reaction and the carbon consumption for the heat supply, except the carburization of the molten iron, are drawn with w(C)_{carburization}+w(C)_{Si,Mn,P} as a starting point, namely after the relation between the carbon consumption and the direct reduction degree is obtained, a constant term (w(C)_{carbrization}+w(C)_{Si,Mn,P}) is added.
Step S4: Determine the direct reduction degree according to a carbon balance relation, and determine predicted values of the various carbon consumption items and a predicted fuel ratio according to the direct reduction degree and the carbon consumption calculation model.

The carbon balance relation is specifically expressed by:

$${w ( C )}_{i} = {C}_{injection} + w ( C ) + {w ( C )}_{carburiztion} + {w ( C )}_{S i , Mn , P} \qquad ( 13 )$$

where, w(C)ᵢ is the amount of the carbon consumption in the chemical reaction, C_{injection} is an equivalent amount of carbon carried in by the injected hydrogen-rich medium, w(C) is the amount of the carbon consumption for the heat supply, w(C)_{carburization} is the amount of the carburization of the BF molten iron, and w(C)_{Si,Mn,P} is the amount of the carbon consumption in the direct reduction of the trace elements.

Specifically, according to the carbon balance relation, equations for calculating C_{injection}, w(C), w(C)_{carburization} and w(C)_{Si,Mn,P} are substituted into Eq. (13), namely Eqs. (1)-(12) are substituted into Eq. (13). On two sides of the resulting equation, only r_{d} is unknown. Solving the equation obtains the direct reduction degree r_{d}. The r_{d} is brought back to the carbon consumption calculation model, thereby obtaining the various carbon consumption items of the BF.

According to the carbon-oxygen balance in front of the tuyere, the predicted fuel ratio is calculated by:

$${K}^{′} = ( w ( C ) + {w ( C )}_{S i , Mn , P} + {w ( C )}_{carburization} ) / {w ( C )}_{k} \qquad ( 14 )$$

where, K′ is the predicted fuel ratio, and w(C)ₖ is a mass percent of carbon in the fuel.
Step S5: Determine whether an absolute value of a difference between the predicted fuel ratio and the initial fuel ratio is less than a preset value to obtain a first determination result. Preferably, the preset value is 0.2.
Step S6: Adjust, if the first determination result indicates no, the initial fuel ratio and the initial blast volume, and go back to Step S2.

Specifically, the initial fuel ratio is updated with a sum of the predicted fuel ratio and the set value. According to the carbon-oxygen balance in front of the tuyere, a predicted blast volume is determined, and the initial blast volume is updated with the predicted blast volume.
Step S7: Calculate, if the first determination result indicates yes, a material balance and a heat balance of the BF according to the direct reduction degree, the reduction degree of the hydrogen and the predicted fuel ratio to obtain calculation results of various indicators, where the calculation results of the various indicators include the predicted values of the various carbon consumption items, carbon emission per ton of iron, the predicted fuel ratio, an RAFT in a tuyere area, a heat loss in a high-temperature area, a temperature of top gas in a low-temperature area, and an overall heat loss of the BF. Generally, the temperature of 900-1,000° C. in the BF is used as a boundary between the high-temperature area and the low-temperature area. The high-temperature area refers to an area with a temperature higher than the boundary, and the low-temperature area refers to an area with a temperature lower than the boundary.

In addition, according to the actual production requirements, the calculation results of the various indicators may further include a distribution of the reduction degree, a coal generation process, a heat balance sheet in the high-temperature area, a heat balance sheet in the low-temperature area, and an overall heat balance sheet and an overall material balance sheet of the BF. Based on the calculation results of the various indicators, the present disclosure can further be used to analyze trends of the various indicators under different hydrogen enrichment conditions to obtain adjustment directions.
Step S8: Determine whether the calculation results of the various indicators satisfy constraints on a material balance and a heat balance in each of areas of the BF to obtain a second determination result, where the constraints on the material balance and the heat balance in each of the areas of the BF include a constraint on a material balance in the tuyere area, a constraint on a heat balance in the tuyere area, a constraint on the RAFT, a constraint on a material balance in the high-temperature area, a constraint on a heat balance in the high-temperature area, a constraint on a material balance in the low-temperature area, a constraint on a heat balance in the low-temperature area, a constraint on a material balance in the whole furnace, and a constraint on a heat balance in the whole furnace.
Step S9: Adjust, if the second determination result indicates no, the heat loss verification coefficient, the raw material and fuel conditions, and the injection parameters, and go back to Step S2.
Step S10: Output, if the second determination result indicates yes, the raw material and fuel conditions, the product parameters, the injection parameters, the heat loss verification coefficient and the corresponding calculation results of the various indicators, where the calculation results of the various indicators are used to evaluate a carbon source, a carbon direction, carbon consumption and carbon emission of the BF.

Specifically, the r_{d}, r_{H2} and various carbon consumption values are substituted into calculation of the material balance and the heat balance in each of the areas of the BF to observe whether the constraints on the RAFT, the high-temperature area, the low-temperature area, the heat balance in the whole furnace and the like are satisfied. If yes, the results are output. If no, the heat loss verification coefficient in the function for calculating the amount of the carbon consumption for the heat supply is adjusted, and the input raw material and fuel conditions and injection parameters are adjusted, until the constraints are satisfied. It is to be noted that upon adjustment, the heat loss accounts for 5-10% of total heat.

Further, after the step of respectively establishing relations of various carbon consumption items of the BF with a direct reduction degree according to the reduction degree of the hydrogen, the raw material and fuel conditions, the product parameters, the injection parameters and the heat loss verification coefficient to obtain a carbon consumption calculation model, the method further includes: Draw and output a carbon consumption line distribution diagram according to the carbon consumption calculation model. From the carbon consumption line distribution diagram, the carbon source and the carbon direction can be directly known.

Specific examples are provided hereinafter to verify correctness of the method.

Example 1: Relations between various carbon consumption items C of the hydrogen-rich BF and r_{d} are established, and intersections are obtained, thereby verifying the calculation method.

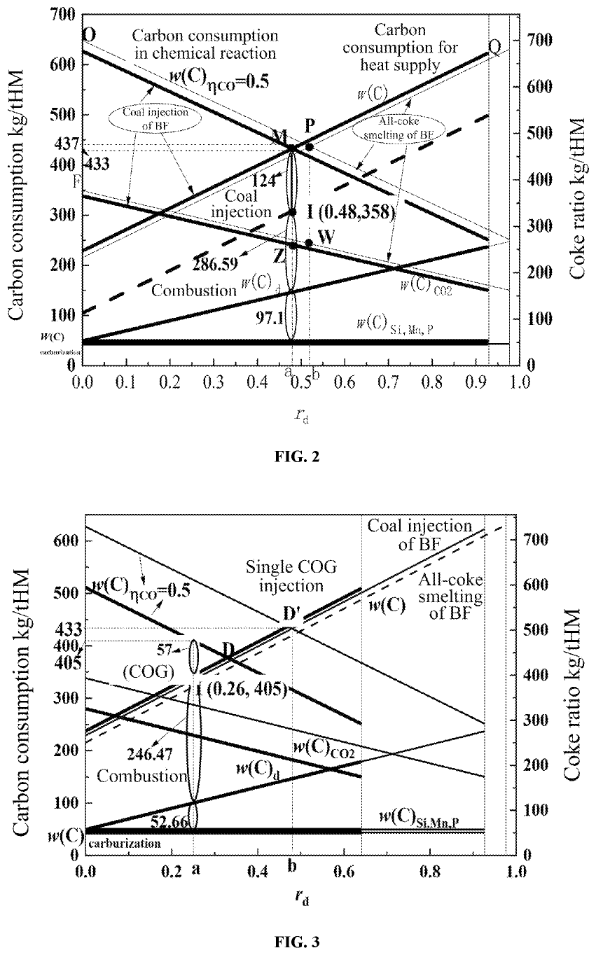

Production parameters from a BF in China are used as an initial condition for calculation. The BF has a CO utilization rate of 50%, thus obtaining the carbon consumption w(C)ᵢ=w(C)_{ηCO=0.5}=1/0.5*w(C)_{CO}_{₂} in chemical reaction. The coal ratio of the BF is fixed at 167 kg/tFe, and the coke ratio (fuel ratio of the BF=fuel ratio+coal ratio) in the fuel ratio of the BF is predicted. With the carbon consumption calculation model of the present disclosure, the coke ratio is 358 kg/tFe. However, the coke ratio of the BF in actual production is 355 kg/tFe. Therefore, the error is less than 1%, which verifies the correctness of the model. Through calculation of the model, the carbon consumption line distribution diagram of the BF in all-coke smelting and coal injection is as shown in FIG. 2. As can be seen from FIG. 2, the carbon consumption of the BF in the all-coke smelting is the crease line OPQ. In the section OP, the carbon consumption of the BF depends on the chemical reaction. In the section PQ, the carbon consumption of the BF depends on the heat supply. In the coal injection of the BF, pulverized coal can carry in a part of hydrogen-containing substances, such that the reduction degree of the hydrogen in the BF is increased, the direct reduction degree r_{d} is lowered, the carbon consumption in the indirect reduction is reduced, the lines w(C)_{CO2}, w(C)_{ηCO}=0.5 move down, and the total carbon consumption of the BF is reduced from 437 kg/tFe at the point P to 433 kg/tFe at the point M. On the other hand, the pulverized coal can particulate in combustion and reduction instead of a part of coke to effectively reduce the coke ratio. As can be seen from FIG. 2, the carbon of the BF in the coal injection comes from the following sources: 124 kg/tFe from the coal injection, and 309 kg/tFe from the coke ratio. Directions of the carbon are as follows: 43.40 kg/tFe for the carburization, 5.83 kg/tFe for the direct reduction of the trace elements, 97.10 kg/tFe for the direct reduction, and 286.59 kg/tFe for the combustion. The total carbon consumption is 433 kg/tFe, and the carbon emission in indirect reduction for generating CO₂ is 191.84 kg/tFe.

Example 2: The coal injection is changed into single COG injection to predict influences of hydrogen enrichment with the single COG injection on carbon consumption of the BF.

300 m³/tHM COG at 25° C. is used as an injection condition. Through calculation of the model, the C-r_{d} line distribution is as shown in FIG. 3. As can be seen from FIG. 3, due to a high content of hydrogen in the COG, the reduction degree of the hydrogen is increased, the carbon consumption w(C)_{d} in the direct reduction and the carbon consumption w(C)_{CO2} in the indirect reduction are significantly reduced, and the carbon consumption w(C) for the heat supply rises slightly. From FIG. 3, with the COG injection, the intersection between the carbon consumption in the chemical reaction and the carbon consumption for the heat supply is changed from D′ to D, the direct reduction degree is changed from b to a, and the total carbon consumption of the BF is reduced from 433 kg/tFe to 405 kg/tFe. 300 Nm³/tFe of COG are injected, such that about 57 kg of carbon is carried in to participate in the indirect reduction or provide excessive CO for the indirect reduction. In the hydrogen-rich injection, the carbon of the BF comes from the following sources: 57 kg/tFe from the COG, and 348 kg/tFe from the coke ratio. Directions of the carbon are as follows: 43.40 kg/tFe for the carburization, 5.83 kg/tFe for the direct reduction of the trace elements, 52.66 kg/tFe for the direct reduction, 246.47 kg/tFe for the combustion, and 57 kg/tFe as the excessive carbon for the indirect reduction. The total carbon consumption is 405 kg/tFe, and the carbon emission in indirect reduction for generating CO₂ is 178.12 kg/tFe. In the hydrogen-rich injection, the carbon consumption for the heat supply is 348 kg/tFe. Assuming that the carbon consumption for the heat supply is only provided by the coke, the coke ratio is 405 kg/tHM, which is significantly higher than that of the coal injection. Therefore, the single COG injection for the hydrogen enrichment can achieve energy conservation and emission reduction of the BF, but cannot reduce the coke ratio of the BF. This indicates that the single COG injection should be combined with the coal injection.

Example 3: The coal injection is changed into hybrid injection of coal and COG to predict influences of hydrogen enrichment with the hybrid injection of the coal and the COG on carbon consumption of the BF.

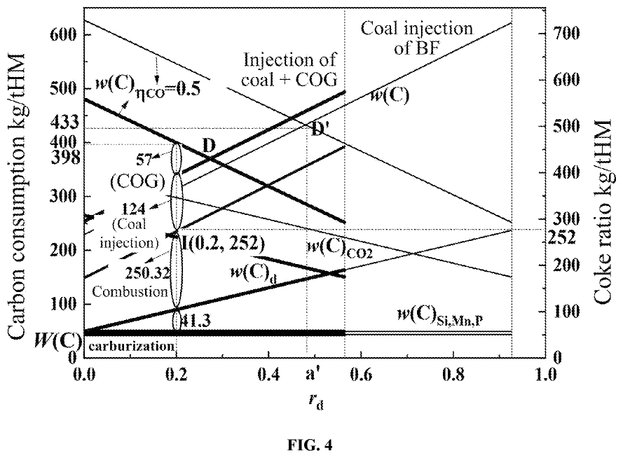

By fixing the coal injection rate at 167 kg/tFe, carbon consumption line distribution of the BF with the hybrid injection of the coal and the COG is as shown in FIG. 4. As can be seen from FIG. 4, the carbon consumption per ton of iron for the BF with the hybrid injection of the coal and the COG is reduced from 433 kg to 398 kg. Meanwhile, the injected hydrogen-containing carbonaceous substances (pulverized coal and COG) participate in the indirect reduction and heat supply instead of a part of coke. In the hydrogen-rich injection, the carbon of the BF comes from the following sources: 57 kg/tFe from the COG, 124 kg/tFe from the pulverized coal, and 217 kg/tFe from the coke ratio. Directions of the carbon are as follows: 43.40 kg/tFe for the carburization, 5.83 kg/tFe for the direct reduction of the trace elements, 41.3 kg/tFe for the direct reduction, 250.32 kg/tFe for the combustion, and 57 kg/tFe as the excessive carbon for the indirect reduction. The total carbon consumption is 398 kg/tFe, and the carbon emission in indirect reduction for generating CO₂ is 174.37 kg/tFe. In the hydrogen-rich injection, the coke ratio is reduced to 252 kg/tFe, which satisfies requirements of the BF on energy conservation and emission reduction. However, by substituting the r_{d}, r_{H2} and predicted fuel ratio in the condition to calculation of the material balance and the heat balance in each of the areas, the RAFT is reduced from 2134° C. to 1642° C. due to little physical heat in the injected COG and a fact that the CH₄ in the COG is cracked dramatically in the tuyere area to cause volume expansion. This indicates that heat at a lower side of the BF is of importance to the BF with the hybrid injection of the coal and the COG, and the heat loss verification coefficient, the raw material and fuel conditions and the injection parameters are further to be adjusted to satisfy the constraints on the material balance and the heat balance in each of the areas of the BF.

Example 4: While the constraints on the material balance and the heat balance in each of the areas of the BF are satisfied, energy conservation and carbon emission effects of different hydrogen enrichment processes that are predicted with the method for predicting carbon consumption and carbon emission of a hydrogen-rich BF based on a C-r_{d} theory are as shown in Table 1. As compared with results of the BF from foreign hydrogen-enrichment test, the present disclosure is reasonable and reliable.

TABLE 1
Comparison of different hydrogen enrichment processes in energy conservation and carbon emission

| | Injection amount | Coke ratio | | CO₂ emission | Comparison at |
|---|---|---|---|---|---|
| Condition | per ton of iron | kg/tFe | RAFT ° C. | reduction % | home and abroad |
| Coal injection | 167 kg/tFe | 358 | 2134 | 1% | BF in China |
| Single COG | 119 | | 2101 | 3% | Japanese COURSE50 |
| injection | Nm³/tFe | | | | project |
| Single COG | 119 | | 2097 | 3.17% | Present disclosure |
| injection | Nm³/tFe | | | | |
| Single H₂ | 310 | | 2091 | 12% | Japanese COURSE50 |
| injection | Nm³/tFe | | | | project |
| Single H₂ | 310 | | 2082 | 11% | Present disclosure |
| injection | Nm³/tFe | | | | |
| Top | Circulation volume | 273 | 1852 | 22.67% | Present disclosure |
| gas-gas-making | 775 | | | | |
| furnace-BF top | Nm³/tFe | | | | |
| gas circulation | | | | | |
| Injection of coal + | 167 kg/tFe of coal + | 305-280 | 1900 | 0-5% | Present disclosure |
| COG | 132.5-357.5 Nm³/tFe | | | | |
| | of COG | | | | |
| Injection of coal + | 167 kg/tFe of coal | 316-300 | 1900 | 9%-13% | Present disclosure |
| H₂ | 167-500 | | | | |
| | Nm³/tFe of H₂ | | | | |
| Injection of coal + | 167 kg/tFe of coal + | 272-182 | 1900 | 19.5%-39.7% | Present disclosure |
| 1200° C. H₂ | 295-800 Nm³/tFe of | | | | |
| | H₂ | | | | |

Each example of the present disclosure is described in a progressive manner, each example focuses on the difference from other examples, and the same and similar parts between the examples may refer to each other.

Specific examples are used herein to explain the principles and embodiments of the present disclosure. The foregoing description of the embodiments is merely intended to help understand the method of the present disclosure and its core ideas; besides, various modifications may be made by those of ordinary skill in the art to specific embodiments and the scope of application in accordance with the ideas of the present disclosure. In conclusion, the content of the present specification shall not be construed as limitations to the present disclosure.

What is claimed is:

1. A method for predicting carbon consumption and carbon emission of a hydrogen-rich blast furnace (BF) based on a C-r_{d} theory, comprising:
inputting raw material and fuel conditions, product parameters, injection parameters and a heat loss verification coefficient of a BF, wherein the raw material and fuel conditions comprise a type of iron ore, a burden structure, an initial fuel ratio, chemical components of a raw material and a fuel, and blast parameters; the blast parameters comprise a blast humidity, a blast temperature, an initial blast volume, an oxygen enrichment rate, and an oxygen (O₂) purity; the product parameters comprise components of molten iron, a temperature of the molten iron, components of slag, a carbon monoxide (CO) utilization rate, components of dust, and a dust volume; and the injection parameters comprise a type of an injected hydrogen-rich medium, an injection amount of the hydrogen-rich medium, an injection temperature, an injection position, and a hydrogen (H₂) utilization rate;
determining a reduction degree of hydrogen according to the blast parameters, the initial fuel ratio and the injection parameters;
respectively establishing relations of various carbon consumption items of the BF with a direct reduction degree according to the reduction degree of the hydrogen, the raw material and fuel conditions, the product parameters, the injection parameters and the heat loss verification coefficient to obtain a carbon consumption calculation model, wherein the various carbon consumption items comprise carburization of BF molten iron, carbon consumption in direct reduction of trace elements, carbon consumption in direct reduction of iron oxide, carbon consumption in chemical reaction, and carbon consumption for heat supply; and the carbon consumption calculation model comprises a function for calculating an amount of the carburization of the BF molten iron, a function for calculating an amount of the carbon consumption in the direct reduction of the trace elements, a function for calculating an amount of the carbon consumption in the direct reduction of the iron oxide, a function for calculating an amount of the carbon consumption in the chemical reaction, and a function for calculating an amount of the carbon consumption for the heat supply;
determining the direct reduction degree according to a carbon balance relation, and determining predicted values of the various carbon consumption items and a predicted fuel ratio according to the direct reduction degree and the carbon consumption calculation model;
determining whether an absolute value of a difference between the predicted fuel ratio and the initial fuel ratio is less than a preset value to obtain a first determination result;
adjusting, if the first determination result indicates no, the initial fuel ratio and the initial blast volume, and going back to the step of “determining a reduction degree of hydrogen according to the blast parameters, the initial fuel ratio and the injection parameters”;
calculating, if the first determination result indicates yes, a material balance and a heat balance of the BF according to the direct reduction degree, the reduction degree of the hydrogen and the predicted fuel ratio to obtain calculation results of various indicators, wherein the calculation results of the various indicators comprise the predicted values of the various carbon consumption items, carbon emission per ton of iron, the predicted fuel ratio, a raceway adiabatic flame temperature (RAFT) in a tuyere area, a heat loss in a high-temperature area, a temperature of top gas in a low-temperature area, and an overall heat loss of the BF;
determining whether the calculation results of the various indicators satisfy constraints on a material balance and a heat balance in each of areas of the BF to obtain a second determination result, wherein the constraints on the material balance and the heat balance in each of the areas of the BF comprise a constraint on a material balance in the tuyere area, a constraint on a heat balance in the tuyere area, a constraint on the RAFT, a constraint on a material balance in the high-temperature area, a constraint on a heat balance in the high-temperature area, a constraint on a material balance in the low-temperature area, a constraint on a heat balance in the low-temperature area, a constraint on a material balance in the whole furnace, and a constraint on a heat balance in the whole furnace;
adjusting, if the second determination result indicates no, the heat loss verification coefficient, the raw material and fuel conditions, and the injection parameters, and going back to the step of “determining a reduction degree of hydrogen according to the blast parameters, the initial fuel ratio and the injection parameters”; and
outputting, if the second determination result indicates yes, the raw material and fuel conditions, the product parameters, the injection parameters, the heat loss verification coefficient and the corresponding calculation results of the various indicators, wherein the calculation results of the various indicators are used to evaluate a carbon source, a carbon direction, carbon consumption and carbon emission of the BF.

2. The method for predicting carbon consumption and carbon emission of a hydrogen-rich BF based on a C-r_{d} theory according to claim 1, wherein the function for calculating the amount of the carbon consumption in the chemical reaction is specifically expressed by:
$${w ( C )}_{i} = {n}_{i} \times \frac{12}{56} ( 1 - {r}_{d} - {r}_{{H}_{2}} ) \times w [ Fe ] + \frac{12}{56} \times {n}_{2} \times \frac{1}{3} ( {r}_{d} + {r}_{{H}_{2}} ) \times w [ Fe ] = \frac{1}{{η}_{CO}} {w ( C )}_{{CO}_{2}} ,$$
wherein, w(C)ᵢ is the amount of the carbon consumption in the chemical reaction, r_{d} is the direct reduction degree, r_{H}_{₂} is the reduction degree of the hydrogen, w[Fe] is a content of ferrum (Fe) in the molten iron, η_{CO} is the CO utilization rate, w(C)_{CO}_{₂} is an amount of carbon reduced to generate carbon dioxide (CO₂), n₁ is an excess coefficient of a reductant CO for reducing ferrous oxide (FeO) to Fe, and n₂ is an excess coefficient of the reductant CO for reducing ferroferric oxide (Fe₃O₄) to FeO.

3. The method for predicting carbon consumption and carbon emission of a hydrogen-rich BF based on a C-r_{d} theory according to claim 1, wherein the function for calculating the amount of the carbon consumption for the heat supply is specifically expressed by:
$$w ( C ) = {w ( C )}_{c ombustion} + {w ( C )}_{d} ,$$
wherein, w(C) is the amount of the carbon consumption for the heat supply, w(C)_{d} is the amount of the carbon consumption in the direct reduction of the iron oxide, and w(C)_{combustion} is an amount of carbon combusted in front of a tuyere.

4. The method for predicting carbon consumption and carbon emission of a hydrogen-rich BF based on a C-r_{d} theory according to claim 2, wherein the amount of the carbon reduced to generate the CO₂ is calculated by:
$${w ( C )}_{{CO}_{2}} = \frac{12}{56} [ Fe ] ( 1 - {r}_{d} - {r}_{{H}_{2}} ) + \frac{1}{2} \times \frac{12}{56} w [ Fe ] .$$

5. The method for predicting carbon consumption and carbon emission of a hydrogen-rich BF based on a C-r_{d} theory according to claim 3, wherein the amount of the carbon combusted in front of the tuyere is calculated by:
$${w ( C )}_{combustion} ( {q}_{CO} + {q}_{hot blast} ) + {Q}_{injection} + {Q}_{others} = {Q}_{reduction} + {Q}_{molten iron} + {Q}_{slag} + {Q}_{top gas} + {Q}_{{H}_{2} O cracking} + {Q}_{heat loss} + {Q}_{cracking of pulverized coal} + {Q}_{{H}_{2} O evaporation} + {Q}^{′} ,$$
wherein, q_{CO} is heat that 1 kg of carbon is combusted in front of the tuyere to generate CO, q_{hot blast} is heat carried in by blast air, Q_{injection} is physical heat carried by the injected hydrogen-rich medium, Q_{reduction} is heat consumed by reduction, Q_{molten iron} is heat carried off by the molten iron, Q_{slag} is heat carried off by the slag, Q_{top gas} is heat carried off by the top gas,
$${Q}_{{H}_{2} O cracking}$$
is heat consumed by cracking of water (H₂O) in front of the tuyere, Q_{cracking of pulverized coal} is heat consumed by cracking of pulverized coal in front of the tuyere,
$${Q}_{{H}_{2} O evaporation}$$
is heat carried off by evaporation of H₂O in the raw material and the fuel of the BF, Q_{heat loss} is a heat loss, Q′ is the heat loss verification coefficient, and Qₒₜₕₑᵣₛ is other heat of the BF, comprising heat carried in by hot charging of the raw material of the BF;
the heat consumed by the reduction is calculated by:
$${Q}_{reduction} = {\sum }_{k} {Q}_{reduction , k} = {Q}_{direct reduction} + {Q}_{indirect reduction} + {Q}_{Si , Mn , P} = \frac{152190}{56} w [ Fe ] \times {r}_{d} + \frac{47522}{2 \times 72} {w}_{silicate} + \frac{1549}{160} {w}_{{Fe}^{2} {O}_{3}} + \frac{20883}{232} {w}_{{Fe}^{3} {O}_{4}} + \frac{27718}{56} w [ Fe ] \times {r}_{{H}_{2}} - \frac{13605}{56} w [ Fe ] ( 1 - {r}_{d} - {r}_{{H}_{2}} ) + 5087 \times w [ Mn ] + 22049 \times w [ Si ] + 15490 \times w [ P ] ,$$
wherein, k denotes different reduction items, Q_{direct reduction} is heat consumed by the direct reduction of the iron oxide, Q_{indirect reduction} is heat consumed by indirect reduction of the iron oxide, Q_{Si,Mn,P} is heat consumed by the reduction of the trace elements, w_{silicate} is a mass of silicon dioxide (SO₂) in an iron bearing material, w_{Fe}_{₂}_{O}_{₃} is a mass of ferric oxide (Fe₂O₃) in the iron bearing material, w_{Fe}_{₃}_{O}_{₄} is a mass of Fe₃O₄ in the iron bearing material, w[Fe] is a content of Fe in the molten iron, w[Mn] is a content of manganese (Mn) in the molten iron, w[Si] is a content of silicon (Si) in the molten iron, w[P] is a content of phosphorus (P) in the molten iron, r_{d} is the direct reduction degree, and r_{H}_{₂} is the reduction degree of the hydrogen; and
the heat carried off by the top gas is calculated by:
$${Q}_{top gas} = {Q}_{{CO}_{2} , top gas} + {Q}_{CO , top gas} + {Q}_{{N}_{2} , top gas} + {Q}_{{H}_{2} , top gas} + {Q}_{{H}_{2} O , top gas} = \frac{{q}_{{CO}^{2} , top gas}}{12} w {( C )}_{{CO}^{2}} + \frac{{q}_{CO , top gas}}{12} ( {w ( C )}_{i} - {w ( C )}_{{CO}_{2}} ) + \frac{{q}_{{N}_{2} , top gas}}{22.4} \times {( {N}_{2} )}_{b} \times {V}_{b} + \frac{{q}_{{H}_{2} , top gas}}{2} {w}_{{H}_{2}} {η}_{{H}_{2}} + \frac{{q}_{{H}_{2} O , top gas}}{2} \times {w}_{{H}_{2}} ( 1 - {η}_{{H}_{2}} )$$
wherein, Q_{CO}_{²}_{,top gas} is heat carried off by CO₂ in the top gas, Q_{CO,top gas} is heat carried off by CO in the top gas,
$${Q}_{{N}_{2} , top gas}$$
is heat carried off by nitrogen (N₂) in the top gas,
$${Q}_{{H}_{2} , top gas}$$
is heat carried off by H₂ in the top gas,
$${Q}_{{H}_{2} O , top gas}$$
is heat carried off by H₂O in the top gas, q_{CO}_{²}_{,top gas} is heat carried off by 1 mol of CO₂ in the top gas, q_{CO,top gas} is heat carried off by 1 mol of CO in the top gas,
$${Q}_{{N}_{2} , top gas}$$
is heat carried off by 1 mol of N₂ in the top gas,
$${Q}_{{H}_{2} , top gas}$$
is heat carried off by 1 mol of H₂ in the top gas,
$${Q}_{{H}_{2} O , top gas}$$
is heat carried off by 1 mol of H₂O in the top gas, w(C)ᵢ is the amount of the carbon consumption in the chemical reaction, w(C)_{CO}_{₂} is the amount of the carbon reduced to generate CO₂, V_{b} is the initial blast volume, (N₂)_{b} is a volume fraction of N₂ in the blast air, η_{H}_{₂} is the H₂ utilization rate, and w_{H}_{₂} is a total volume of H₂ charged to the furnace.

6. The method for predicting carbon consumption and carbon emission of a hydrogen-rich BF based on a C-r_{d} theory according to claim 1, wherein the function for calculating the amount of the carbon consumption in the direct reduction of the iron oxide is specifically expressed by:
$${w ( C )}_{d} = \frac{12}{56} \times w [ Fe ] \times {r}_{d} ,$$
wherein, w(C)_{d} is the amount of the carbon consumption in the direct reduction of the iron oxide, w[Fe] is a content of Fe in the molten iron, and r_{d} is the direct reduction degree.

7. The method for predicting carbon consumption and carbon emission of a hydrogen-rich BF based on a C-r_{d} theory according to claim 1, wherein the carbon balance relation is specifically expressed by:
$${w ( C )}_{i} = {C}_{injection} + w ( C ) + {w ( C )}_{carburization} + {w ( C )}_{S i , Mn , P} ,$$
wherein, w(C)ᵢ is the amount of the carbon consumption in the chemical reaction, C_{injection} is an equivalent amount of carbon carried in by the injected hydrogen-rich medium, w(C) is the amount of the carbon consumption for the heat supply, w(C)_{carburization} is the amount of the carburization of the BF molten iron, and w(C)_{Si,Mn,P} is the amount of the carbon consumption in the direct reduction of the trace elements.

8. The method for predicting carbon consumption and carbon emission of a hydrogen-rich BF based on a C-r_{d} theory according to claim 1, wherein the predicted fuel ratio is calculated by:
$${K}^{′} = ( w ( C ) + {w ( C )}_{Si , Mn , P} + {w ( C )}_{carburization} ) / {w ( C )}_{k} ,$$
wherein, K′ is the predicted fuel ratio, the w(C) is the amount of the carbon consumption for the heat supply, w(C)_{carburization} is the amount of the carburization of the BF molten iron, w(C)_{Si,Mn,P} is the amount of the carbon consumption in the direct reduction of the trace elements, and w(C)ₖ is a mass percent of carbon in the fuel.

9. The method for predicting carbon consumption and carbon emission of a hydrogen-rich BF based on a C-r_{d} theory according to claim 1, wherein the adjusting the initial fuel ratio and the initial blast volume specifically comprises:
updating the initial fuel ratio with a sum of the predicted fuel ratio and the preset value; and
determining a predicted blast volume according to a carbon-oxygen balance in front of a tuyere, and updating the initial blast volume with the predicted blast volume, wherein the predicted blast volume is calculated by:
$${V}_{b}^{′} = \frac{{w ( C )}_{c o mbustion} \times 22.4}{24 \times {v ( {O}_{2} )}_{b}} ,$$
wherein, V_{b}′ is the predicted blast volume, w(C)_{combustion} is an amount of carbon combusted in front of the tuyere, and v(O₂)_{b} is a volume fraction of O₂ in blast air.

10. The method for predicting carbon consumption and carbon emission of a hydrogen-rich BF based on a C-r_{d} theory according to claim 1, after the respectively establishing relations of various carbon consumption items of the BF with a direct reduction degree according to the reduction degree of the hydrogen, the raw material and fuel conditions, the product parameters, the injection parameters and the heat loss verification coefficient to obtain a carbon consumption calculation model, further comprising:
drawing and outputting a carbon consumption line distribution diagram according to the carbon consumption calculation model.
